(19) United States
(12) Patent Application Publication
(10) Pub. No.: US 2006/0280981 A1
(43) Pub. Date: Dec. 14, 2006

(54) Polymer electrolyte membrane having an improved dimensional stability

(75) Inventor: Ramandeep Mehmi, Livermore, CA (US)

Correspondence Address: Richard F. Trecartin;Dorsey & Whitney LLP, Intellectual Property Department, 555 California Street, Suite 1000, San Francisco, CA, 94104-1513, US

(73) Assignee: Polyfuel, Inc.

(21) Appl. No.: 11/445,629

(22) Filed: Jun. 2, 2006

Related U.S. Application Data
(60) Provisional application No. 60/687,408, filed on Jun. 2, 2005.

(51) Int. Cl. H01M 8/10; C08J 5/22

(52) U.S. Cl. 429/30; 521/27

(57) ABSTRACT

The invention provides anisotropic polymer electrolyte membranes that can be used to fabricate catalyst coated membranes (CCM's) and membrane electrode assemblies (MEA's) that are useful in fuel cells.

### CROSS-REFERENCE TO RELATED APPLICATION

The present application claims priority to U.S. Provisional Application No. 60/687,408 filed Jun. 2, 2005 which is hereby incorporated by reference in its entirety.

### FIELD OF THE INVENTION

Polymer electrolyte membranes having improved dimensional stability, methods of making such membranes and fuel cells containing them.

### BACKGROUND OF THE INVENTION

Fuel cells are promising power sources for portable electronic devices, electric vehicles, and other applications due mainly to their non-polluting nature. Of various fuel cell systems, polymer electrolyte membrane based fuel cells such as direct methanol fuel cells (DMFCs) and hydrogen fuel cells, have attracted significant interest because of their high power density and energy conversion efficiency. The “heart” of a polymer electrolyte membrane based fuel cell is the so called “membrane-electrode assembly” (MEA), which comprises a proton exchange membrane (PEM), catalyst disposed on the opposite surfaces of the PEM to form a catalyst coated membrane (CCM) and a pair of electrodes (i.e., an anode and a cathode) disposed to be in electrical contact with the catalyst layer. Proton-conducting membranes for DMFCs are known, such as Nafion® from the E.I. Dupont De Nemours and Company or analogous products from Dow Chemical. These perfluorinated hydrocarbon sulfonate ionomer products, however, have serious limitations when used in high temperature fuel cell applications. Nafion® loses conductivity when the operation temperature of the fuel cell is over 80° C. Moreover, Nafion® has a very high methanol crossover rate, which impedes its applications in DMFCs.

U.S. Pat. No. 5,773,480, assigned to Ballard Power System, describes a partially fluorinated proton conducting membrane from α, β, β-trifluorostyrene. One disadvantage of this membrane is its high cost of manufacturing due to the complex synthetic processes for monomer α, β, β-trifluorostyrene and the poor sulfonation ability of poly (α, β, β-trifluorostyrene). Another disadvantage of this membrane is that it is very brittle, thus has to be incorporated into a supporting matrix.

U.S. Pat. Nos. 6,300,381 and 6,194,474 to Kerrres, et al. describe an acid-base binary polymer blend system for proton conducting membranes, wherein the sulfonated poly(ether sulfone) was made by post-sulfonation of the poly (ether sulfone).

M. Ueda in the Journal of Polymer Science, 31(1993): 853, discloses the use of sulfonated monomers to prepare the sulfonated poly(ether sulfone polymers).

U.S. Patent Application US 2002/0091225A1 to McGrath, et al. used this method to prepare sulfonated polysulfone polymers.

Ion conductive block copolymers are disclosed in PCT/US2003/015351.

A good membrane for fuel cell operations requires balancing various properties of the membrane. Such properties included proton conductivity, fuel-resistance, chemical stability and fuel crossover, especially for high temperature applications, fast start up of DMFCs, and durability. In addition, it is important for the membrane to retain its dimensional stability over the fuel operational temperature range. Conventional PEM's swell isotropically when exposed to fuels such as methanol. Such dimensional changes may cause failure of the fuel cell through failure of the PEM catalyst interface, failure of a sealing function, or through membrane movement within the fuel cell leading to aberrant flow distribution or other problems. The lack of dimensional stability can also lead to poor response of the fuel cell if the PEM is allowed to dry out because of lack of fuel. The in-plane dimensionally stability of the membrane is therefore important in forming PEM's used in fuel cells.

### SUMMARY OF THE INVENTION

PEM's that are dimensionally stable are made by mechanically processing an isotropically swollen PEM. This converts the PEM into an anisotropically swelling PEM.

The methods comprise hot pressing a swollen ion conductive membrane having first and second opposing planar membrane surfaces to form an anisotropically swelling PEM. In the hot pressing at least the first surface of the swollen membrane is contacted with a first perforated member having first and second faces. The first face is in contact with all or part of the first surface of the membrane. The second face of the perforated member and/or the perforations in the member are optionally in contact with an absorbent material. The PEM so formed has unique in-plane dimensional stability as demonstrated by its anisotropic swelling perpendicular to the membrane plane when exposed to water, methanol or a mixture of both.

The method can also include the use of a second perforated member having first and second faces, where the first face is contacted with the second surface of the membrane. The second face of the perforated member and/or its perforation can optionally be in contact with an adsorbent material

The membrane can be a continuous web of material produced from casting a solution containing an ion conducting polymer. The membrane web should contain sufficient solvent so that the membrane is in a swollen state. When using a membrane web, the perforated member is preferably a perforated cylinder that hot presses the swollen membrane as it passes the cylinder in a continuous fashion.

The anisotropic PEM can be used to fabricate catalyst coated polymer electrolyte membranes (CCM's) and membrane electrode assemblies (MEA's) that find particular utility in hydrogen fuel cells and direct methanol fuel cells. Such fuel cells can be used in electronic devices, both portable and fixed, power supplies including auxiliary power units (APU's), residential power supplies, backup power supplies and as locomotive power for vehicles such as automobiles, aircraft and marine vessels and APU's associated therewith.

The invention also includes a hot press comprising at least one or two perforated members positioned so that a first surface of the perforated member(s) can be placed in contact with the surface(s) of a membrane being hot pressed. A second surface of the perforated member(s) is optionally adapted to contact an absorbent material.

### BRIEF DESCRIPTION OF THE DRAWING

FIG. 1 defines the dimensions of a typical PEM. The width of a membrane is measured in the X^{M} dimension. If the sheet is long, as in a web process, X^{M} will equal the width of a roll of the sheet. The length of the sheet is measured in the Y^{M} dimension. The thickness of the sheet is measured in the Z^{M} dimension.

FIG. 2 depicts the hot pressing of a swollen membrane to form a PEM with improved dimensional stability.

### DETAILED DESCRIPTION OF THE INVENTION

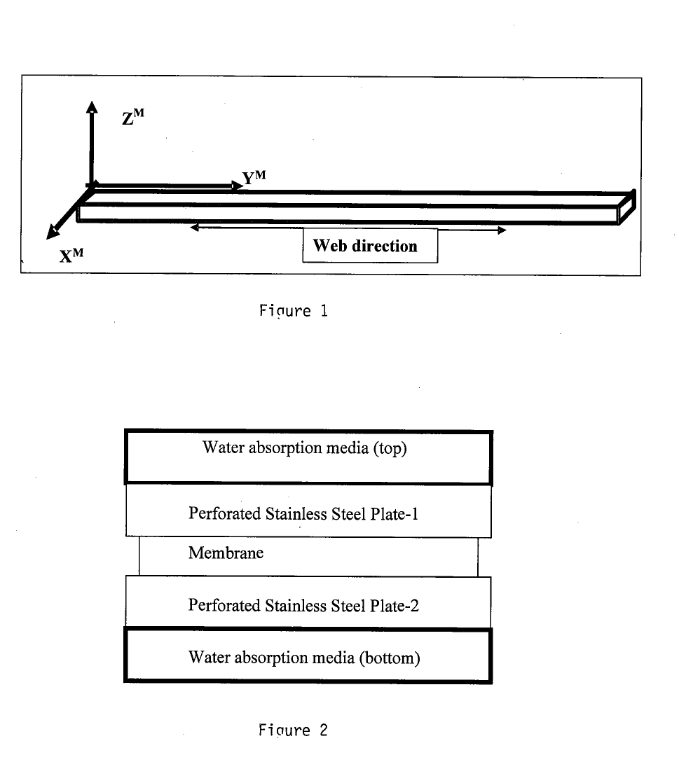

The dimensions of a PEM are set forth in FIG. 1 where X^{M} and Y^{M} define the plane of the PEM and Z^{M} defines the dimension perpendicular to the X^{M}, Y^{M} plane. In one aspect, the invention minimizes the dimensional change of a PEM in the X^{M}, Y^{M} plane when exposed to water and/or liquid fuel.

As used herein, “swelling” of a membrane occurs when water or another liquid is absorbed by the membrane causing an increase in volume. As used herein, “anisotropic swelling” refers to the swelling in one dimension which is different from the swelling over the other dimension (s). As used herein, “isotropic swelling” refers to equal or nearly equal swelling in all dimensions.

The methods comprise hot pressing a swollen ion conductive membrane having first and second opposing planar surfaces with perforated members to form a PEM that anisotropically swells in the Z^{M} dimension. In the hot pressing, at least the first surface of the swollen membrane is contacted with a first perforated member having first and second faces. The first face is in contact with all or part of the first surface of the membrane while the second face of the perforated member and/or its perforations are optionally in contact with an absorbent material. The PEM so formed has unique in-plane dimensional stability as demonstrated by its anisotropic swelling when exposed to water, methanol or a mixture of both. Such anisotropic PEM's do not significantly swell in X^{M}, Y^{M} plane of the membrane as compared to the membrane swelling in the Z^{M} dimension.

The swollen membrane can contain a non-aqueous solvent, water or a combination of both. Alternatively, the swollen membrane can be washed with water prior to hot pressing to form a hydrated membrane that is substantially free of the casting solvent.

The method can also include the use of a second perforated member having first and second faces, where the first face is contacted with the second surface of the membrane. The second face of the perforated member and/or its perforation can optionally be in contact with an adsorbent material.

The membrane can be a continuous web of material produced from casting of a solution containing an ion conducting polymer. The polymer membrane web should contain sufficient solvent so that the membrane is in a swollen state. The membrane is then treated in a continuous fashion by hot pressing with at least one perforated member. When using a membrane web, the perforated member is preferably a perforated cylinder that hot press the continuous web as the swollen membrane passes the cylinders.

The hot pressing is carried out at a temperature above the Tg of the swollen membrane and less than the Tg of the membrane when dried. The hot pressing is carried out at a pressure of between 10 and 50 kg/cm2. After hot pressing, the membrane is cooled, preferably at a rate of at least 15 C/second.

The anisotropic PEM contains islands on the surfaces treated with the perforated member. These islands are in a predetermined pattern that is defined by the perforations in the hot press member. These islands provide the additional advantage of increasing the surface area of the PEM. This can result in enhanced bonding of the catalyst layer and an increase in the current produced by the CCM so produced.

The invention also includes a hot-press (discrete and continuous). Hot presses have previously been used to anneal PEM's. Generally, these devices contain flat solid plates that are used to press the PEM. In the present invention, these plates can be perforated for use in making anisotropic PEM's. Alternatively, perforated plates can be added to the hot press by affixing them to the solid plates. In some instances, an absorbent material may be placed between the solid plates and the perforated plates to facilitate the drying of the membrane. During hot pressing the perforations allow liquid or gas to escape from the membrane. The perforated plate may be used in combination with a wicking material to facilitate liquid or gas transport. A preferred absorbing material is a lint free cloth such as TX409 from TexWipe, Mahwan, N.J.

The perforations in the plates are generally circular having a diameter from 125 to 200 microns and more preferably between about 150 and 180 microns. The perforations are placed in a geometric pattern, for example, repetitive hexagons. The size and number of perforations are chosen so that approximately 15-50%, more preferably 25-35% and most preferably about 30% of the surface area of the plate is perforated. Perforated plates useful in practicing the invention can be obtained from McMaster-Carr®, Atlanta, Ga. and include Part Nos. 92315T101, 9255T581, 9255T451, and 9255T151.

When using one or more perforated plates, the PEM's cell so formed contain islands on the treated surfaces. These islands conform generally to the dimensions of the perforations and are positioned in conformity with the pattern of perforations on the pressing plate. These islands have a height of approximately one micron or less. They typically have a height of approximately one micron or less.

The ion-conductive copolymers can comprise any ion conducting polymer or a blend of ion conducting polymer and non-ionic polymer. The ion-conducting polymer is preferably a copolymer comprising or more ion-conductive oligomers distributed in a polymeric backbone where the polymeric backbone contains at least one, two or three, preferably at least two, of the following: (1) one or more ion conductive monomers, (2) one or more non-ionic monomers and (3) one or more non-ionic oligomers. The ion conducting oligomers, ion-conducting non-ionic monomers and/or non-ionic oligomers are covalently linked to each other by oxygen and/or sulfur.

In a preferred embodiment, the ion-conducting oligomer comprises first and second comonomers. The first comonomer comprises one or more ion-conducting groups. At least one of the first or second comonomers comprises two leaving groups while the other comonomer comprises two displacement groups. In one embodiment, one of the first or second comonomers is in molar excess as compared to the other so that the oligomer formed by the reaction of the first and second comonomers contains either leaving groups or displacement groups at each end of the ion-conductive oligomer. This precursor ion-conducting oligomer is combined with at least two of: (1) one or more precursor ion conducting monomers; (2) one or more precursor non-ionic monomers and (3) one or more precursor non-ionic oligomers. The precursor ion-conducting monomers, non-ionic monomers and/or non-ionic oligomers each contain two leaving groups or two displacement groups. The choice of leaving group or displacement group for each of the precursor is chosen so that the precursors combine to form an oxygen and/or sulfur linkage.

The term “leaving group” is intended to include those functional moieties that can be displaced by a nucleophilic moiety found, typically, in another monomer. Leaving groups are well recognized in the art and include, for example, halides (chloride, fluoride, iodide, bromide), tosyl, mesyl, etc. In certain embodiments, the monomer has at least two leaving groups. In the preferred polyphenylene embodiments, the leaving groups may be “para” to each other with respect to the aromatic monomer to which they are attached. However, the leaving groups may also be ortho or meta.

The term “displacing group” is intended to include those functional moieties that can act typically as nucleophiles, thereby displacing a leaving group from a suitable monomer. The monomer with the displacing group is attached, generally covalently, to the monomer that contained the leaving group. In a preferred polyarylene example, fluoride groups from aromatic monomers are displaced by phenoxide, alkoxide or sulfide ions associated with an aromatic monomer. In polyphenylene embodiments, the displacement groups are preferably para to each other. However, the displacing groups may be ortho or meta as well.

Table 1 sets forth combinations of exemplary leaving groups and displacement groups. The precursor ion conducting oligomer contains two leaving groups fluorine (F) while the other three components contain fluorine and/or hydroxyl (—OH) displacement groups. Sulfur linkages can be formed by replacing —OH with thiol (—SH). The displacement group F on the ion conducing oligomer can be replaced with a displacement group (eg —OH) in which case the other precursors are modified to substitute leaving groups for displacement groups or to substitute displacement groups for leaving groups.

TABLE 1
Exemplary Leaving Groups (Fluorine) and
Displacement Group (OH) Combinations

| | | Precursor Ion | |
|---|---|---|---|
| Precursor Ion | Precursor Non | Conducting | Precursor Non |
| Conducting Oligomer | Ionic Oligomer | Monomer | Ionic Monomer |
| 1) F | OH | OH | OH |
| 2) F | F | OH | OH |
| 3) F | OH | F | OH |
| 4) F | OH | OH | F |
| 5) F | F | F | OH |
| 6) F | F | OH | F |
| 7) F | OH | F | F |

Preferred combinations of precursors is set forth in lines 5 and 6 of Table 1.

The ion-conductive copolymer may be represented by Formula I:
[[—(Ar₁—T—)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula I

wherein Ar₁, Ar₂, Ar₃ and Ar₄ are independently the same or different aromatic moieties, where at least one of Ar1 comprises an ion conducting group and where at least one of Ar₂ comprises an ion-conducting group;

T, U, V and W are linking moieties;

X is independently —O— or —S—;

i and j are independently integers greater than 1;

a, b, c, and d are mole fractions wherein the sum of a, b ,c and d is 1, a is zero or greater than zero and at least two of b, c and d are greater than 0; and

m, n, o, and p are integers indicating the number of different oligomers or monomers in the copolymer.

The preferred values of a, b, c, and d, i and j as well as m, n, o, and p are set forth below.

The ion conducting copolymer may also be represented by Formula II:
[[—(Ar₁—T—)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula II

wherein

Ar₁, Ar₂, Ar₃ and Ar₄ are independently phenyl, substituted phenyl, napthyl, terphenyl, aryl nitrile and substituted aryl nitrile;

at least one of Ar1comprises an ion-conducting group;

at least one of Ar2 comprises an ion-conducting group;

T, U, V and W are independently a bond, —C(O)—,

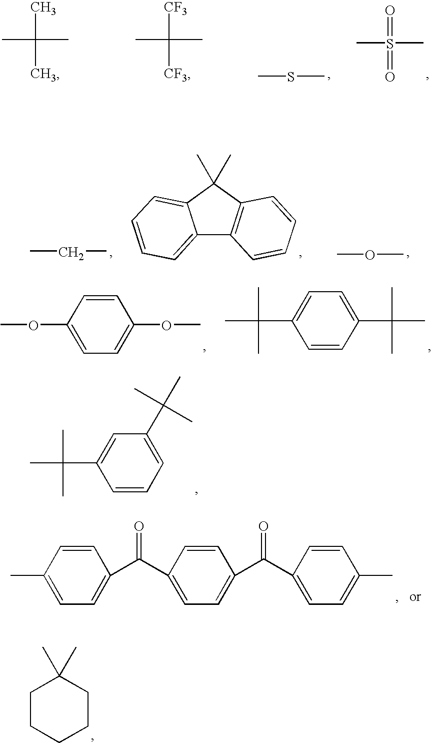

X is independently —O— or —S—;

i and j are independently integers greater than 1; and

a, b, c, and d are mole fractions wherein the sum of a, b ,c and d is 1, a is zero or greater than zero and at least two of b, c and d are greater than 0; and

m, n, o, and p are integers indicating the number of different oligomers or monomers in the copolymer.

The ion-conductive copolymer can also be represented by Formula III:
[[—(Ar₁—T—)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula III

wherein

Ar₁, Ar₂, Ar₃ and Ar₄ are independently phenyl, substituted phenyl, napthyl, terphenyl, aryl nitrile and substituted aryl nitrile;

where T,U,V and W are independently a bond O, S, C(O), S(O₂), alkyl, branched alkyl, fluoroalkyl, branched fluoroalkyl, cycloalkyl, aryl, substituted aryl or heterocycle;

X is independently —O— or —S—;

i and j are independently integers greater than 1;

a, b, c, and d are mole fractions wherein the sum of a, b ,c and d is 1, a is zero or greater than zero and at least two of b, c and d are greater than 0; and

m, n, o, and p are integers indicating the number of different oligomers or monomers in the copolymer.

In each of the forgoing formulas I, II and III [—(Ar₁—T—)_{i—Ar}₁—]ₐ^{m} is an ion conducting oligomer; (—Ar₂—U—Ar₂—)_{b}ⁿ is an ion conducting monomer; [(—Ar₃—V—)_{j—Ar}₃]_{c}^{o} is a non-ionic oligomer; and (—Ar₄—W—Ar₄—) _{d} ^{p} is a non-ionic monomer. Accordingly, in some cases these formulas are directed to ion-conducting polymers that include ion conducting oligomer(s) in combination at least two of the following: (1) one or more ion conductive monomers, (2) one or more non-ionic monomers and (3) one or more non-ionic oligomers.

In preferred embodiments, i and j are independently from 2 to 12, more preferably from 3 to 8 and most preferably from 4 to 6.

The mole fraction “a” of ion-conducting oligomer in the copolymer is between 0 and 0.9, preferably between 0.1 and 0.9, more preferably between 0.3 and 0.7 and most preferably between 0.3 and 0.5.

The mole fraction “b” of ion conducting monomer in the copolymer is preferably from 0 to 0.5, more preferably from 0.1 to 0.4 and most preferably from 0.1 to 0.3.

The mole fraction of “c” of non-ion conductive oligomer is preferably from 0 to 0.3, more preferably from 0.1 to 0.25 and most preferably from 0.01 to 0.15.

The mole fraction “d” of non-ion conducting monomer in the copolymer is preferably from 0 to 0.7, more preferably from 0.2 to 0.5 and most preferably from 0.2 to 0.4.

The indices m, n, o, and p are integers that take into account the use of different monomers and/or oligomers in the same copolymer or among a mixture of copolymers where m is preferably 1, 2 or 3, n is preferably 1 or 2, o is preferably 1 or 2 and p is preferably 1, 2, 3 or 4.

In some embodiments at least two of Ar₂, Ar₃ and Ar₄ are different from each other. In another embodiment Ar₂, Ar₃ and Ar₄ are each different from the other.

In some embodiments, when there is no hydrophobic oligomer, i.e. when c is zero in Formulas I, II, or III: (1) the precursor ion conductive monomer used to make the ion-conducting polymer is not 2,2′ disulfonated 4,4′ dihydroxy biphenyl; (2) the ion conductive polymer does not contain the ion-conducting monomer that is formed using this precursor ion conductive monomer; and/or (3) the ion-conducting polymer is not the polymer made according to Example 3 herein.

Ion conducting copolymers and the monomers used to make them and which are not otherwise identified herein can also be used. Such ion conducting copolymers and monomers include those disclosed in U.S. patent application Ser. No. 09/872,770, filed Jun. 1, 2001, Publication No. US 2002-0127454 A1, published Sep. 12, 2002, entitled “Polymer Composition” ; U.S. patent application Ser. No. 10/351,257, filed Jan. 23, 2003, Publication No. US 2003-0219640 A1, published Nov. 27, 2003, entitled “Acid Base Proton Conducting Polymer Blend Membrane”; U.S. patent application Ser. No. 10/438,186, filed May 13, 2003, Publication No. US 2004-0039148 A1, published Feb. 26, 2004, entitled “Sulfonated Copolymer”; U.S. patent application Ser. No. 10/438,299, filed May 13, 2003, entitled “Ion-conductive Block Copolymers,” published Jul. 1, 2004, Publication No. 2004-0126666; U.S. application Ser. No. 10/449,299, filed Feb. 20, 2003, Publication No. US 2003-0208038 A1, published Nov. 6, 2003, entitled “Ion-conductive Copolymer”; U.S. patent application Ser. No. 10/438,299, filed May 13, 2003, Publication No. US 2004-0126666; U.S. patent application Ser. No. 10/987,178, filed Nov. 12, 2004, entitled “Ion-conductive Random Copolymer”, Publication No.2005-0181256 published Aug. 18, 2005; U.S. patent application Ser. No. 10/987,951, filed Nov. 12, 2004, Publication No. 2005-0234146, published Oct. 20, 2005, entitled “Ion-conductive Copolymers Containing First and Second Hydrophobic Oligomers;” U.S. patent application Ser. No. 10/988,187, filed Nov. 11, 2004, Publication No. 2005-0282919, published Dec. 22, 2005, entitled “Ion-conductive Copolymers Containing One or More Hydrophobic Oligomers”; and U.S. patent application Ser. No. 11/077,994, filed Mar. 11, 2005, Publication No. 2006-004110, published Feb. 23, 2006, each of which are expressly incorporated herein by reference. Other comonomers include those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35:1348 (2002)); polyimides (U.S. Pat. No. 6,586,561 and J. Membr. Sci. 160:127 (1999)) and Japanese Patent Applications Nos. JP2003147076 and JP2003055457, each of which are expressly identified herein by reference.

Although the copolymers used in the invention have been described in connection with the use of arylene polymers, the principle of using ion-conductive oligomers in combination with at least two of: (1) one or more ion conducting comonomers ; (2) one or more non-ionic monomers and (3) one or more non-ionic oligomers, can be applied to many other systems. For example, the ionic oligomers, non-ionic oligomers as well as the ionic and non-ionic monomers need not be arylene but rather may be aliphatic or perfluorinated aliphatic backbones containing ion-conducting groups. Ion-conducting groups may be attached to the backbone or may be pendant to the backbone, e.g., attached to the polymer backbone via a linker. Alternatively, ion-conducting groups can be formed as part of the standard backbone of the polymer. See, e.g., U.S. 2002/018737781, published Dec. 12, 2002 incorporated herein by reference. Any of these ion-conducting oligomers can be used to practice the present invention.

The following are some of the monomers used to make ion-conductive copolymers.

1) Precursor Difluoro-end Monomers

| Acronym | Full name | Molecular weight | Chemical structure |
|---|---|---|---|
| Bis K | 4,4′-Difluorobenzophenone | 218.20 | 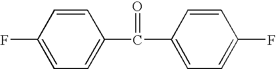 |
| Bis SO₂ | 4,4′-Difluorodiphenylsulfone | 254.25 | 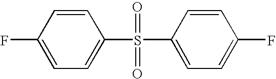 |
| S-Bis K | 3,3′-disulfonated-4,4′-di- fluorobenzophone | 422.28 | 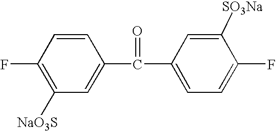 |

2) Precursor Dihydroxy-end Monomers

| | | | |
|---|---|---|---|
| Bis AF (AF or 6F) | 2,2-Bis(4-hydroxyphenyl)hexa- fluoropropane or 4,4′-(hexafluoroisopropylidene) diphenol | 336.24 | 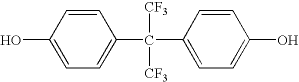 |
| BP | Biphenol | 186.21 | 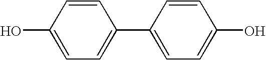 |
| Bis FL | 9,9-Bis(4-hydroxyphenyl)fluorene | 350.41 | 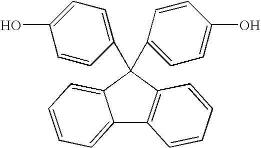 |
| Bis Z | 4,4′-cyclohexylidenebisphenol | 268.36 | 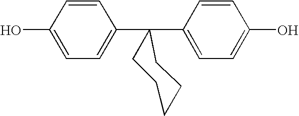 |
| Bis S | 4,4′-thiodiphenol | 218.27 | 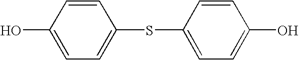 |

3) Precursor Dithiol-end Monomer

| | | Molecu- | |
|---|---|---|---|
| Acro- | Full | lar | |
| nym | name | weight | Chemical Structure |
| | 4,4′-thiol bis benzene thiol | | 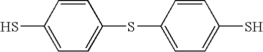 |

Formula IV is an example of a preferred random copolymer where n and m are mole fractions, where n is between 0.5 and 0.9 and m is between 0.1 and 0.5. A preferred ratio is where n is 0.7 and m is 0.3.

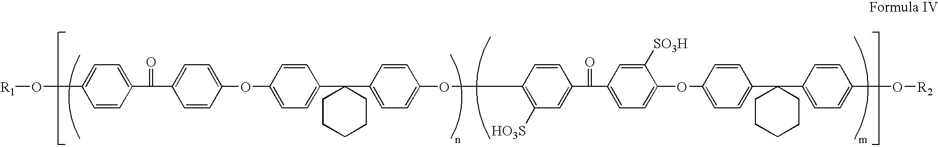

The mole percent of ion-conducting groups when only one ion-conducting group is present is preferably between 30 and 70%, or more preferably between 40 and 60%, and most preferably between 45 and 55%. When more than one conducting group is contained within the ion-conducting monomer, such percentages are multiplied by the total number of ion-conducting groups per monomer. Thus, in the case of a monomer comprising two sulfonic acid groups, the preferred sulfonation is 60 to 140%, more preferably 80 to 120%, and most preferably 90 to 110%. Alternatively, the amount of ion-conducting group can be measured by the ion exchange capacity (IEC). By way of comparison, Nafion® typically has a ion exchange capacity of 0.9 meq per gram. In the present invention, it is preferred that the IEC be between 0.9 and 3.0 meq per gram, more preferably between 1.0 and 2.5 meq per gram, and most preferably between 1.6 and 2.2 meq per gram.

The amount of ion-conducting group can be measured by the ion exchange capacity (IEC). By way of comparison, Nafion® typically has an ion exchange capacity of 0.9 meq per gram. In the present invention, it is preferred that the IEC be between 0.4 and 3.0 meq per gram, more preferably between 0.7 and 2.0 meq per gram, and most preferably between 0.9 and 1.7 meq per gram.

Polymer membranes may be fabricated by solution casting or by hot-melt extrusion of the ion-conductive copolymer. Alternatively, the polymer membrane may be fabricated by solution casting the ion-conducting polymer the blend of the acid and basic polymer.

Polymer membranes may be fabricated by solution casting of the ion-conductive copolymer.

When cast into a membrane for use in a fuel cell, it is preferred that the membrane thickness be between 0.1 to 10 mils, more preferably between 1 and 6 mils, most preferably between 1.5 and 2.5 mils.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion membrane of the same thickness. In preferred embodiments the permeability of methanol is preferably 50% less than that of a Nafion membrane, more preferably 75% less and most preferably greater than 80% less as compared to the Nafion membrane.

After the ion-conducting copolymer has been formed into a membrane, it may be used to produce a catalyst coated membrane (CCM). As used herein, a CCM comprises a PEM when at least one side and preferably both of the opposing sides of the PEM are partially or completely coated with catalyst. The catalyst is preferable a layer made of catalyst and ionomer. Preferred catalysts are Pt and Pt-Ru. Preferred ionomers include Nafion and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum or platinum/ruthenium is generally applied on the anode side, and platinum is applied on the cathode side. Catalysts may be optionally supported on carbon. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

The CCM is used to make MEA's. As used herein, an MEA refers to an ion-conducting polymer membrane made from a CCM according to the invention in combination with anode and cathode electrodes positioned to be in electrical contact with the catalyst layer of the CCM.

The electrodes are in electrical contact with the catalyst layer, either directly or indirectly via a gas diffusion or other conductive layer, so that they are capable of completing an electrical circuit which includes the CCM and a load to which the fuel cell current is supplied. More particularly, a first catalyst is electrocatalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the anode to the load and then to the cathode. Balancing this direct electron current is the transfer of an equivalent number of protons across the membrane to the cathodic compartment. There an electrocatalytic reduction of oxygen in the presence of the transmitted protons occurs to form water. In one embodiment, air is the source of oxygen. In another embodiment, oxygen-enriched air or oxygen is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output. Such applications include electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

Such CCM and MEM's are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The CCM's and MEA's of the invention may also be used in hydrogen fuel cells that are known in the art. Examples include U.S. Pat. Nos. 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

The ion-conducting polymer membranes of the invention also find use as separators in batteries. Particularly preferred batteries are lithium ion batteries.

### EXAMPLES

### Example 1

The anisotropic membrane can be made by first swelling a membrane such as the random copolymer in formula IV with methanol or a methanol-water solution, followed by washing with DI (de-ionized water) to remove Methanol. The washed membrane is then hot pressed (150 C—above hydrated Tg, 15 kg/cm2 compressive pressure, 45 sec) between two perforated stainless steel sheets that are covered with a cloth-like material, as depicted in FIG. 2. With a significant amount of water present in the membrane, the Tg (Glass Transition Temperature) is lowered and as the membrane loses water while in the hot press, the Tg moves back up to near dry membrane Tg. The stainless steel plates apply uniform pressure and allow water to escape to the cloth which acts like an absorbent. The membrane surfaces make contact with the stainless steel plates, not the cloth.

### Example 2

The anisotropic membrane does not swell in the X and Y plane (surface plane) but does swell in the Z (normal to surface) plane. This anisotropic behavior, swelling principally in the Z direction (thickness), can be achieved for other PEMs from other polymer families particularly polymers with aromatic rings in the backbone structure. The anisotropic membrane exhibits higher conductivities and water uptake along with increased Z/X ratio for swelling, as shown in Table 2 below. The table shows comparison of standard DMFC membrane made from the random copolymer of Formula IV with the anisotropic membrane made from the same polymer.

TABLE 2

| | Standard DMFC (PFI) | Oriented Polymer (OP) |
|---|---|---|
| Property | Membrane | Membrane |
| Swelling in X | 9.2 | 4 |
| Swelling in XY (area) | 19.2 | 8.2 |
| Swelling in Z | 23 | 45.4 |
| Anisotropy Ratio Z/X | ˜2.5 | 11.4 |
| Conductivity (S/cm) | ˜0.032 | 0.051 |
| Water uptake (% wt) | 24 | 45.5 |

### Example 3

A membrane made from random copolymer, formula IV, 5 cm×5 cm is swollen in methanol-water solution, 85% methanol by weight, for 16 hours, followed by a DI (de-ionized) water soak for 30 minutes with change in water every 10 minutes. The membrane is then placed between “stack” shown in FIG. 2, and hot pressed at 150° C. with pressure of 1 kg/cm2 for 45 seconds. The resulting membrane swells anisotropically once exposed to solvent/water solutions. In 85 wt % Methanol/water solution the membrane swells <8% in X^{M} and Y^{M} dimension and swells 86% in the Z^{M} dimension.

### Example 4

A membrane made from random copolymer, formula IV, 5 cm×5 cm is swollen in methanol-water solution, 85% methanol by weight, for 16 hours, followed by a DI (de-ionized) water soak for 30 minutes with change in water every 10 minutes. The membrane is then placed between “stack” shown in FIG. 2, and hot pressed at 120° C.-170° C. with pressure of 10 kg/cm2-50 kg/cm² for 15-45 seconds. The resulting membrane swells anisotropically once exposed to solvent/water solutions. In 85 wt % Methanol/water solution the membrane swells <8% in X^{M} and Y^{M} dimension and swells 86% in the Z^{M} dimension.

### Example 5

A membrane made from a random copolymer 5 cm×5 cm is swollen in methanol-water solution, 85% methanol by weight, for 16 hours, followed by a DI (de-ionized) water soak for 30 minutes with change in water every 10 minutes. The membrane is then placed between “stack” shown in FIG. 2, and hot pressed at 150° C. with pressure of 10 kg/cm2 for 45 seconds. The resulting membrane swells anisotropically once exposed to solvent/water solutions. In 85 wt % Methanol/water solution the membrane swells <8% in X^{M} and Y^{M} dimension and swells 86% in the Z^{M} dimension.

### Example 6

The swelling of the anisotropic membrane is substantially reduced in the X^{M} and Y^{M} plane (surface plane) but does swell in the Z^{M} (normal to surface) plane. This anisotropic behavior, swelling principally in the Z^{M} dimension (thickness), can be achieved for other PEMs from other polymer families particularly polymers with aromatic rings in the backbone structure. The anisotropic membrane exhibits higher conductivities and water uptake along with increased Z^{M}/X^{M} ratio for swelling, as shown in Table 3 below. The table shows comparison of standard DMFC membrane made from the random copolymer of Formula IV with the anisotropic membrane made from the same polymer. Comparison of anisotropic membrane to its parent standard membrane (prepared according to Example 1, 2, 3, 4, and 5) once soaked in 85 wt % methanol (in methanol water solution) at room temperature.

TABLE 3

| | Standard DMFC | Anisotropic |
|---|---|---|
| Property | (Polyfuel Inc.) Membrane | Membrane |
| Swelling in X^{M} | 1 | ¼ |
| Swelling in X^{M}Y^{M} (area) | 1 | ¼ |
| Swelling in Z^{M} | 1 | 3 |
| Anisotropy Ratio Z^{M}/X^{M} | 1 | 11.6 |
| Conductivity (S/cm) | 1 | 1 |
| Water content (% volume) | 1 | 1.1 |

What is claimed is:

1. A method of making an anisotropic polymer electrolyte membrane (PEM) comprising:
(a) providing a swollen ion conductive membrane having first and second opposing planar surfaces; and
(b) hot pressing said swollen membrane to form an anisotropic PEM, where at least a first opposing surface of said swollen membrane is contacted with a first perforated member having first and second faces, where said first face is in contact with all or part of said first opposing surface of said swollen membrane and said second face of said perforated member is optionally in contact with an absorbent material;
wherein when contacted with water and methanol said anisotropic PEM does not significantly swell in the X^{M}, Y^{M} plane of the membrane as compared to the Z^{M} dimension perpendicular to said X^{M}, Y^{M} plane.

2. The method of claim 1 wherein said hot pressing further comprises the use of a second perforated member having first and second faces, where said first face is contacted with the second opposing surface of said membrane and said second face is in contact with an adsorbent material.

3. The method of claim 1 wherein the perforations in said member comprise holes having a diameter between 125 and 200 microns.

4. The method of claim 1 wherein the perforations in said perforated member comprise between 15 and 50% of the area of said first face of said member.

5. The method of claim 1 wherein the perforations in said member are arranged in a repetitive pattern.

6. The method of claim 1 wherein said perforated member is a perforated cylinder and said hot pressing is of a continuous web of said swollen membrane.

7. The method of claim 1 wherein said hot pressing is at a temperature above the Tg of said swollen membrane and less than the Tg of the membrane when dried.

8. The method of claim 1 wherein the pressure of said hot pressing is between 10 and 50 kg/cm2.

9. The method of claim 1 further comprising cooling said membrane after said hot pressing at a rate of at least 15 C/second.

10. The method of claim 9 wherein said cooling is at a rate of from 15 C/second to 25 C/sec.

11. A PEM made according to any of claims 1-10.

12. A PEM having a membrane plane defined by dimensions X^{M} and Y^{M} and a thickness in the Z^{M} dimension perpendicular to said X^{M}, Y^{M} plane, wherein said PEM has improved dimensional stability in said X^{M}, Y^{M} plane.

13. The PEM of claim 12 wherein said PEM swells anisotropically in said Z^{M} dimension as compared to the swelling in said X^{M}, Y^{M} plane.

14. A PEM comprising an ion conductive polymer having first and second opposing planar surfaces, wherein at least one of said surfaces comprises a plurality of raised islands of said ion conductive polymer.

15. The PEM of claim 14 wherein said raised islands comprise a predetermined array on said surface.

16. A catalyst coated membrane (CCM) comprising the PEM of claim 12 wherein all or part of at least one opposing surface of said PEM comprises a catalyst layer.

17. A membrane electrode assembly (MEA) comprising the CCM of claim 16.

18. A MEA comprising the CCM of claim 1 or 6 where at least one of said opposing surfaces comprises an electrode bonded to said surface.

19. A fuel cell comprising the MEA of claim 18.

20. The fuel cell of claim 19 comprising a hydrogen or methanol fuel cell.

21. An electronic device comprising the fuel cell of claim 19.

22. A power supply comprising the fuel cell of claim 19.

23. An electric motor comprising the fuel cell of claim 19.

24. A vehicle comprising the electric motor of claim 23.

25. A hot press for treating a polymer electrolyte membrane (PEM) comprising at least one perforated planar membrane adapted to be placed in contact with a PEM treated with said hot press.
